(19) United States
(12) Patent Application Publication
(10) Pub. No.: US 2011/0179374 A1
(43) Pub. Date: Jul. 21, 2011

(54) INFORMATION PROCESSING APPARATUS AND PROGRAM

(75) Inventors: Nobutaka YAGI, Kanagawa (JP); Osamu ISHIOKA, Chiba (JP); Ryoji AMEMIYA, Kanagawa (JP); Yohei KURODA, Tokyo (JP); Kenji WAKU, Kanagawa (JP)

(73) Assignee: Sony Corporation, Tokyo (JP)

(21) Appl. No.: 12/983,462

(22) Filed: Jan. 3, 2011

(30) Foreign Application Priority Data
Jan. 20, 2010 (JP) 2010-010405

(51) Int. Cl. G06F 3/048

(52) U.S. Cl. 715/773

(57) ABSTRACT

A display apparatus includes a housing, an operation position specification section, and a display control section. The housing includes a touch panel, and is configured to display a predetermined software keyboard including keys on a display screen. The operation position specification section is configured to specify an operation position of each of the keys of the software keyboard; and a display control section is configured to automatically change display of the keys based on variations of the operation positions of the keys, the operation positions being specified by the operation position specification section.

### BACKGROUND OF THE INVENTION

1. Field of the Invention

The present invention relates to an information processing apparatus and a program for improving the operability of a software keyboard.

2. Description of the Related Art

In recent years, there is proposed a method of displaying a predetermined software keyboard on a display screen of an apparatus including a touch panel, and making a key input by a finger touching the screen on which keys of the software keyboard are displayed (see, for example, Japanese Patent Application Laid-open No. 2006-86934).

### SUMMARY OF THE INVENTION

However, in a case where inputs are made with a software keyboard in touch typing, since keys are not physically independent, the positions of the respective keys are difficult to be distinguished, as compared to a hardware-type (mechanical-type) keyboard. As a result, typing errors are increased and an input speed is lowered, which is not necessarily a comfortable input environment.

On the other hand, in a case where the size of each key of the software keyboard is uniformly increased, a space for displaying other information is reduced on the screen, which lacks convenience. Particularly, since a display screen of a portable device is not large, it may be impossible to enlarge a display area of the software keyboard immoderately.

In view of the circumstances as described above, it is desirable to provide a new and improved information processing apparatus and program that are capable of automatically changing the display of a software keyboard in accordance with operation situations of a user.

According to an embodiment of the present invention, there is provided a display apparatus including: a housing including a touch panel, configured to display a predetermined software keyboard including keys on a display screen; an operation position specification section configured to specify an operation position of each of the keys of the software keyboard; and a display control section configured to automatically change display of the keys based on variations of the operation positions of the keys, the operation positions being specified by the operation position specification section.

With this structure, based on the variations of the operation positions of the keys of the software keyboard, the display of the keys is automatically changed. In other words, based on the variations of the operation positions of the keys, the software keyboard automatically adjusts the position, size, and shape of the keys to the operation states of a user. Accordingly, it is possible to improve the operability of the software keyboard, reduce typing errors, raise an input speed, and streamline operations.

The display control section may display an operation area of the key having a large variation more largely than that of the key having a small variation based on the variations of the operation positions of the keys.

The display control section may obtain the center of the operation positions of each of the keys based on the variations of the operation positions, and change a display position of each of the keys in accordance with the obtained center of the operation positions.

The display control section may obtain a standard deviation of each of the keys based on the variations of the operation positions, and set a width of each of the keys in accordance with a width of the obtained standard deviation.

When each of the keys is displayed based on the center of the operation positions and the width of the key, and adjacent keys are displayed in an overlapping manner, the display control section may set a portion displayed in the overlapping manner as a dead zone to which a key input is incapable of being made.

According to another embodiment of the present invention, there is provided a display apparatus including: a housing including a touch panel, configured to display a predetermined software keyboard including keys on a display screen; a number-of-operations specification section configured to specify the number of operations made to each of the keys of the software keyboard; and a display control section configured to automatically change display of the keys based on the number of operations made to the keys, the number of operations being specified by the number-of-operations specification section.

With this structure, based on the number of operations made to the keys of the software keyboard, the display of the keys is automatically changed. In other words, based on the number of operations made to the keys, the software keyboard automatically adjusts the position, size, and shape of the keys to the operation states of a user. Accordingly, it is possible to improve the operability of the software keyboard, reduce typing errors, raise an input speed, and streamline operations.

The display control section may display an operation area of the key having a large number of operations more largely than that of the key having a small number of operations based on the number of operations made to the keys.

The number-of-operations specification section may obtain a peak position of the operations made to each of the keys based on the number of operations made to each of the keys, and the display control section may obtain a peak position of the operations made to each of the keys based on the number of operations made to each of the keys and change a display position of the key based on the peak position.

The display control section may set a boundary between the peak positions of adjacent keys in accordance with a ratio of the numbers of operations of the adjacent keys.

Further, according to another embodiment of the present invention, there is provided a display apparatus including: a housing including a touch panel, configured to display a predetermined software keyboard including keys on a display screen; an erroneous input position specification section configured to specify an erroneous input position of each of the keys of the software keyboard; and a display control section configured to automatically change display of the keys based on the erroneous input positions of the keys, the erroneous input positions being specified by the erroneous input position specification section.

With this structure, based on the erroneous input positions of the keys of the software keyboard, the display of the keys is automatically changed. For example, the display control section may display an operation area of the key having a large number of erroneous inputs more largely than that of the key having a small number of erroneous inputs based on the erroneous input positions of the keys. Further, the display control section may change a display position of each of the keys based on the erroneous input positions of the keys.

As described above, based on the erroneous input positions of the keys, the software keyboard automatically adjusts the position, size, and shape of the keys to the operation states of a user. Accordingly, it is possible to improve the operability of the software keyboard, reduce typing errors, raise an input speed, and streamline operations.

The display control section may change at least one of a display position and an operation area of a key adjacent to each of the keys based on the erroneous input positions of the keys.

The display control section may change display of at least one of a key operation area for a right hand and a key operation area for a left hand, based on the erroneous input positions of the keys.

The display control section may change display of the keys by varying a boundary position of each key one of per given period of time during which the software keyboard is operated and per given number of times typing is made on the software keyboard.

Further, according to another embodiment of the present invention, there is provided a program causing a computer to execute: a function of a display apparatus including a housing that includes a touch panel and is configured to display a predetermined software keyboard including keys on a display screen; a function of an operation position specification section configured to specify an operation position of each of the keys of the software keyboard; and a function of a display control section configured to automatically change display of the keys based on variations of the operation positions of the keys, the operation positions being specified by the operation position specification section.

Further, according to another embodiment of the present invention, there is provided a program causing a computer to execute: a function of a display apparatus including a housing that includes a touch panel and is configured to display a predetermined software keyboard including keys on a display screen; a function of a number-of-operations specification section configured to specify the number of operations made to each of the keys of the software keyboard; and a function of a display control section configured to automatically change display of the keys based on the number of operations made to the keys, the number of operations being specified by the number-of-operations specification section.

Further, according to another embodiment of the present invention, there is provided a program causing a computer to execute: a function of a display apparatus including a housing that includes a touch panel and is configured to display a predetermined software keyboard including keys on a display screen; a function of an erroneous input position specification section configured to specify an erroneous input position of each of the keys of the software keyboard; and a function of a display control section configured to automatically change display of the keys based on the erroneous input positions of the keys, the erroneous input positions being specified by the erroneous input position specification section.

As described above, according to the embodiments of the present invention, it is possible to automatically change display of a software keyboard in accordance with operation situations of a user.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a diagram showing an example of an initial display screen of a PC according to first to third embodiments and modified examples of the present invention;

FIG. 2 is a functional structure diagram of the PC according to the first embodiment;

FIG. 3A is a diagram for explaining an automatic change of the display of a software keyboard according to the first embodiment;

FIG. 3B is a diagram for explaining an automatic change of the display of the software keyboard according to the first embodiment;

FIG. 3C is a diagram for explaining an automatic change of the display of the software keyboard according to the first embodiment;

FIG. 3D is a diagram for explaining an automatic change of the display of the software keyboard according to the first embodiment;

FIG. 4 is a flowchart of the display change processing of the software keyboard according to the first embodiment;

FIG. 5 is a diagram showing an example of a key input state of a PC according to a second embodiment of the present invention;

FIG. 6 is a functional structure diagram of the PC according to the second embodiment of the present invention;

FIG. 7 is a flowchart of the display change processing of a software keyboard according to the second embodiment;

FIG. 8 is a diagram for explaining results on display change of the software keyboard according to the second embodiment;

FIG. 9 is a diagram showing an example of an erroneous input state of a PC according to a third embodiment of the present invention;

FIG. 10 is a functional structure diagram of the PC according to the third embodiment of the present invention;

FIG. 11 is a flowchart of the display change processing of a software keyboard according to the third embodiment;

FIG. 12A is a diagram for explaining results on display change of the software keyboard according to the third embodiment;

FIG. 12B is a diagram for explaining a method of displaying a software keyboard according to a modified example; and

FIG. 13 is a diagram for explaining a method of displaying a software keyboard according to a modified example.

### DESCRIPTION OF PREFERRED EMBODIMENTS

Hereinafter, embodiments of the present invention will be described in detail with reference to the attached drawings. It should be noted that in this specification and drawings, constituent elements having substantially the same functional structure are denoted by the same reference numeral and overlapping description thereof is omitted.

It should be noted that the embodiments of the present invention will be described in the following order.

### First Embodiment

[Example of display screen of PC]

[Functional structure of PC]

[Display change of software keyboard]

[Results on display change of software keyboard]

### Second Embodiment

[Operation example of display screen of PC]

[Functional structure of PC]

[Display change of software keyboard]

[Results on display change of software keyboard]

### Third Embodiment

[Example of erroneous input of PC]

[Functional structure of PC]

[Display change of software keyboard]

[Results on display change of software keyboard]

### MODIFIED EXAMPLE

[Display change of software keyboard]

### First Embodiment

[Example of display screen of PC]

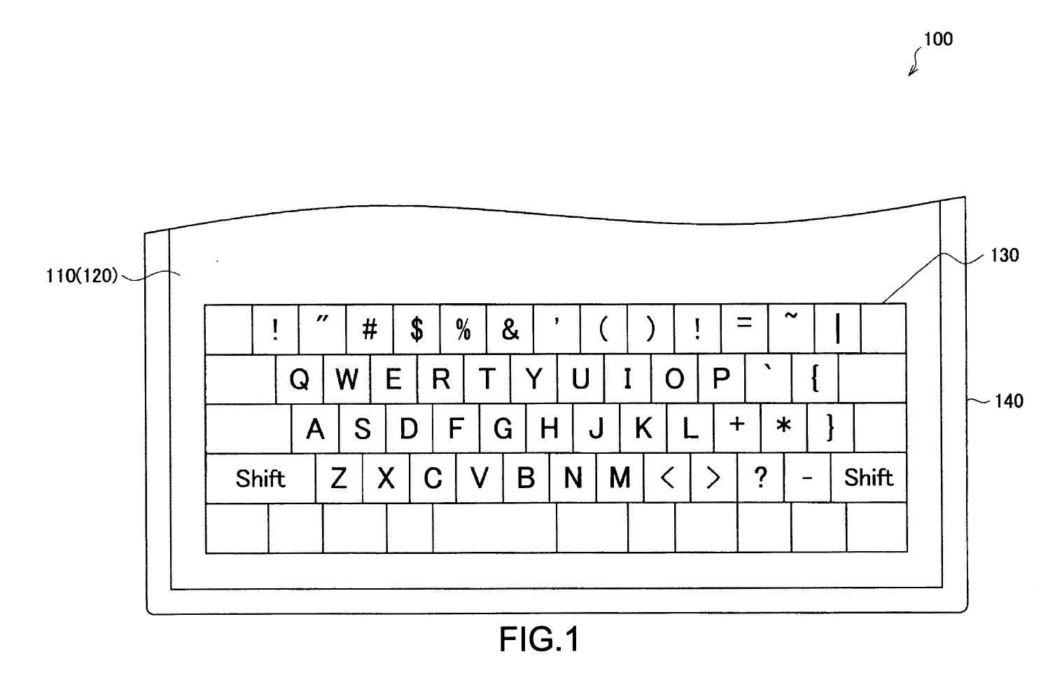

First, an example of an initial display screen of a PC (Personal Computer) 100 as a display apparatus according to the first embodiment of the present invention will be described with reference to FIG. 1. After that, an automatic display change method for a software keyboard according to the first embodiment of the present invention will be described.

The PC 100 as a display apparatus according to the first embodiment includes a housing 140 including a touch panel 110, in which a predetermined software keyboard 130 is displayed on a display screen 120. The touch panel 110 is a sensor that can detect a position of a finger of a user.

As the display screen 120, for example, an LCD (Liquid Crystal Display) or an organic electroluminescence display (organic EL, OELD) can be used.

In this embodiment, a QWERTY keyboard is displayed as the software keyboard 130, but this embodiment is not limited thereto. This embodiment is applicable to various software keyboards 130 such as a numerical keypad.

It should be noted that the PC 100 incorporates a chip including a CPU, a RAM, a nonvolatile memory, and the like (not shown). In various memories, information on a screen operation detected by the touch panel 110 (for example, key input history information) is stored. Further, in the various memories, a program for executing display change processing that will be described later is stored. The CPU executes the display change processing by acquiring necessary data from the memories while reading the program.

[Functional Structure of PC]

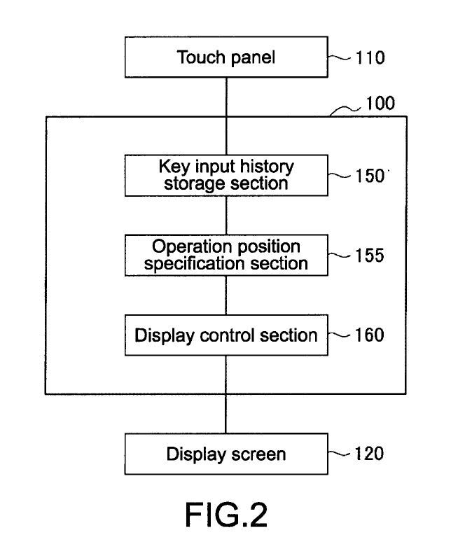

A functional structure of the PC 100 according to this embodiment will be described with reference to FIG. 2. The PC 100 includes a key input history storage section 150, an operation position specification section 155, and a display control section 160.

The key input history storage section 150 stores logs (histories) of user operations made to the software keyboard 130, which are detected using the touch panel 110.

The operation position specification section 155 specifies an operation position of each key of the software keyboard 130.

The display control section 160 automatically changes the display of keys based on variations of the operation positions of the keys, which are specified by the operation position specification section 155. On the display screen 120, the software keyboard 130 with the changed keys is displayed.

[Display Change of Software Keyboard]

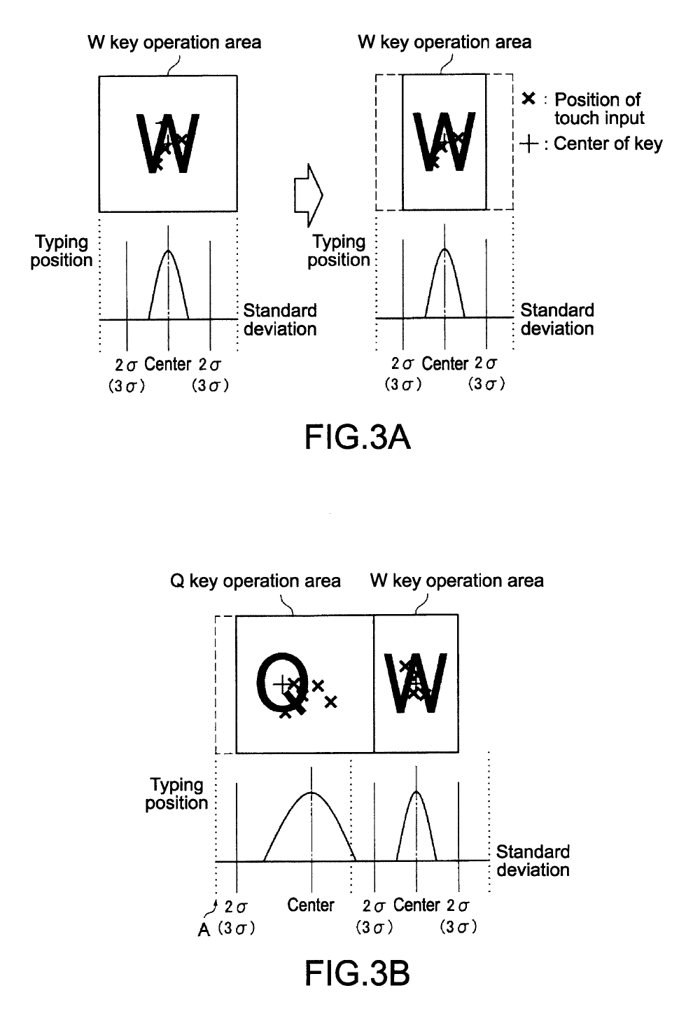

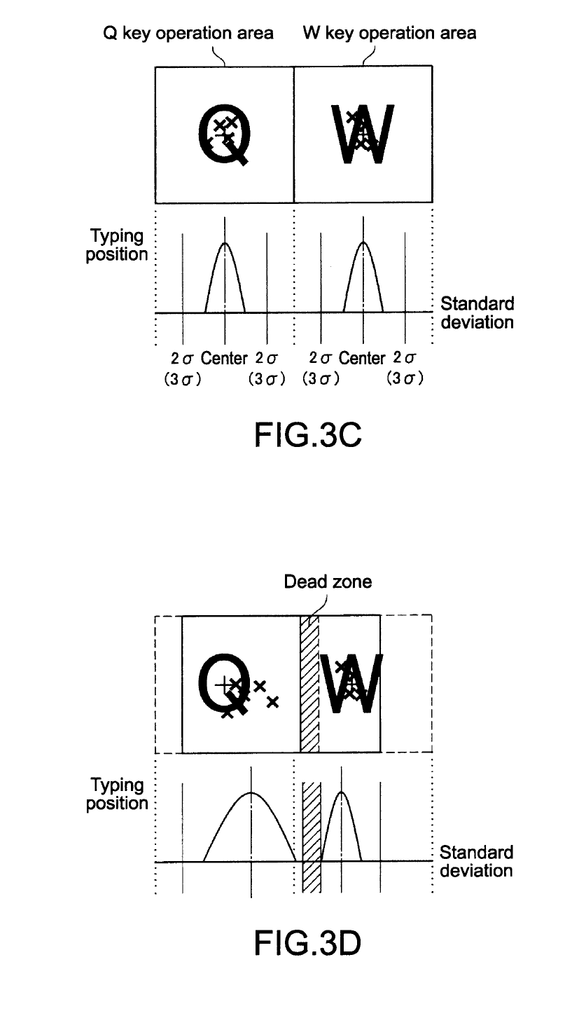

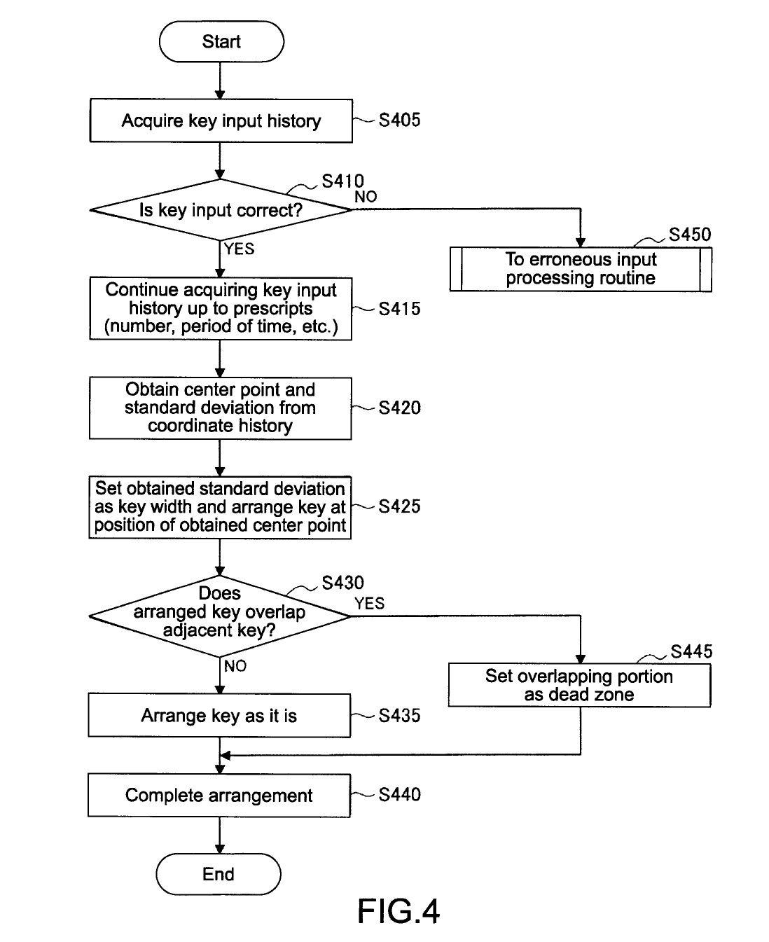

Next, the display change of the software keyboard according to this embodiment will be described with reference to a relationship between key input histories and key display changes shown in FIGS. 3A to 3D and a flowchart shown in FIG. 4.

In this embodiment, based on the variations of the operation positions of the keys (note that only history information of correct input operations is used), the display of each key is automatically changed. In other words, the shape of the key is changed in accordance with habits of key input made by each user. As the habits of key input made by each user, positions at which typographical errors are liable to be caused, variations of position (variations of touch position), and the like are included.

The left-side illustration of FIG. 3A shows an initial display state of a W key. Below the W key, the distribution of typing positions within an operation area of the W key is shown in the vertical axis, and a standard deviation from the center of the typing positions is shown in the horizontal direction. For example, in FIG. 3A, the touch input at three positions within the operation area of the W key is performed in a predetermined period of time. In this case, a standard deviation (2σ or 3σ) with the center of the W key as the center is obtained. As a result, as shown in the right-side illustration of FIG. 3A, the size at the position of the W key (operation area of W key) is changed to be a width with the standard deviation of 2σ or 3σ. The accuracy of the key input can be maintained at the probability of 0.954 in 2σ, and the probability of 0.997 in 3σ.

The above operations will be described with reference to the flowchart of the display change processing of the software keyboard 130 shown in FIG. 4. It should be noted that as a premise of starting this processing, it is assumed that the history information (key input history information) of typing positions for each key of the software keyboard 130 is stored in the key input history storage section 150.

First, in S405, the operation position specification section 155 acquires key input history information from the key input history storage section 150. In S410, the operation position specification section 155 judges whether the key input is correct. For example, in a case where an input is intended to be made with the W key, when a point within the operation area of the W key is hit, the key input is correct and accordingly the processing proceeds to S415.

In S415, the operations of S405 to S415 are repeated until a predetermined period of time is passed or a predetermined number of pieces of key input history information is obtained, and continues acquiring the key input history information. In S420, the operation position specification section 155 specifies operation positions of each key (coordinate histories) that are included in the key input history information, and obtains a standard deviation and a center point of the key input area. In S425, the display control section 160 automatically changes the display of the key based on variations of the operation positions of the key that are specified by the operation position specification section 155. Specifically, the display control section 160 sets the obtained standard deviation as a key width and arranges the key at the position of the obtained center point serving as the center.

Next, in S430, the display control section 160 judges whether the arranged key overlaps an adjacent key. When it is judged that the arranged key does not overlap an adjacent key, the processing proceeds to S435. The display control section 160 determines an operation area of the key that is arranged while the set center point and key width are held as they are, and displays the operation area on the display screen 120 in S440, thus completing the change in arrangement.

On the other hand, in a case where it is judged that the key arranged in S430 overlaps an adjacent key, the processing proceeds to S445. The display control section 160 sets the portion displayed as an overlapping portion, as a dead zone in which a key input is not made. For example, in FIG. 3D, a portion in which the distributions in a Q key and a W key adjacently arranged overlap each other is a dead zone, and it is possible to inhibit input operations of both the Q key and the W key.

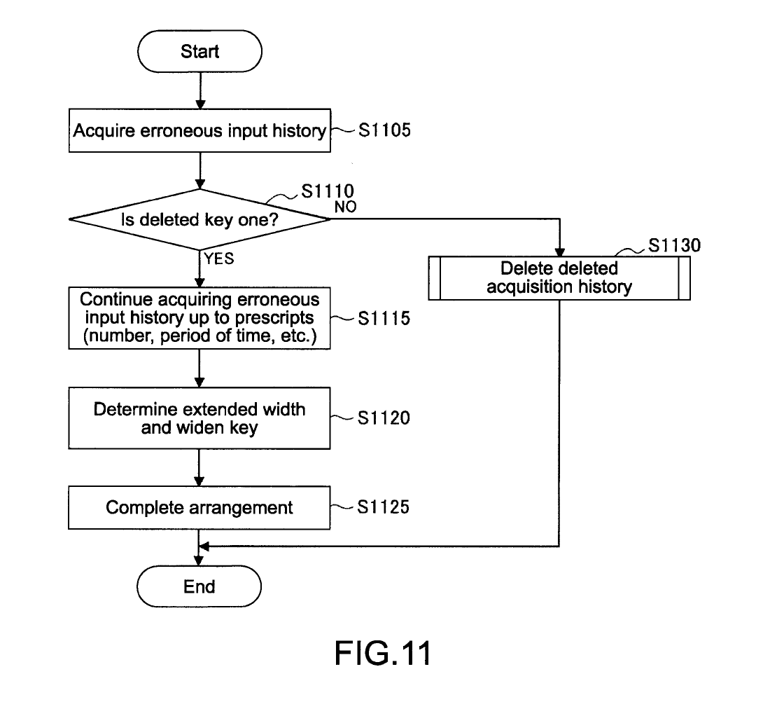

In addition, in a case where the key input is incorrect in S410, the processing proceeds to S450 and an erroneous input processing routine is executed. The erroneous input processing routine is executed based on a flowchart shown in FIG. 11. The erroneous input processing routine will be described in the third embodiment.

[Results on Display Change of Software Keyboard]

Processing results of this embodiment will be described with reference to FIGS. 3B to 3D. In FIG. 3B, the typing point of the W key has a small variation, and the center of the typing point is not shifted to the right side. On the other hand, the typing point of the Q key has a large variation, and the center of the typing point of the Q key is shifted. As a result, the operation position of the W key is not changed and only the operation area of the W key is reduced. On the other hand, the operation position of the Q key is shifted to the right side and the operation area of the Q key is increased. It should be noted that a position of the Q key on the left side (boundary A) may not be shifted, and may be left as it is.

As described above, in this embodiment, the display control section 160 displays, based on the variations in operation positions of the keys, an operation area of a key having a large variation more largely than an operation area of a key having a small variation. Further, the display control section 160 obtains the center of the operation positions of each key based on the variations of the operation positions, and changes a display position of each key in accordance with the obtained center of the operation position.

As described above, in this embodiment, the shape of the key is changed in accordance with a correct key input. Particularly, in this embodiment, the key is enlarged when a shift of the typing position of the key is large. Accordingly, it is possible to improve the operability of the software keyboard 130, reduce typing errors, raise an input speed, and streamline operations.

It should be noted that when the typing position of the key is not shifted so much, the key operation area can be reduced, or the key operation area can be left as it is without change. For example, as shown in FIG. 3C, in a case where the Q key and W key adjacently arranged each have the distribution of typing positions that is smaller than the original key size thereof, the operation area of the Q key and the W key may not be changed.

Further, in this embodiment, the boundary between the keys adjacent in the lateral direction is changed. However, a boundary between keys adjacent in a vertical direction can be changed or both the boundaries between the keys adjacent in the lateral and vertical directions may be changed.

### Second Embodiment

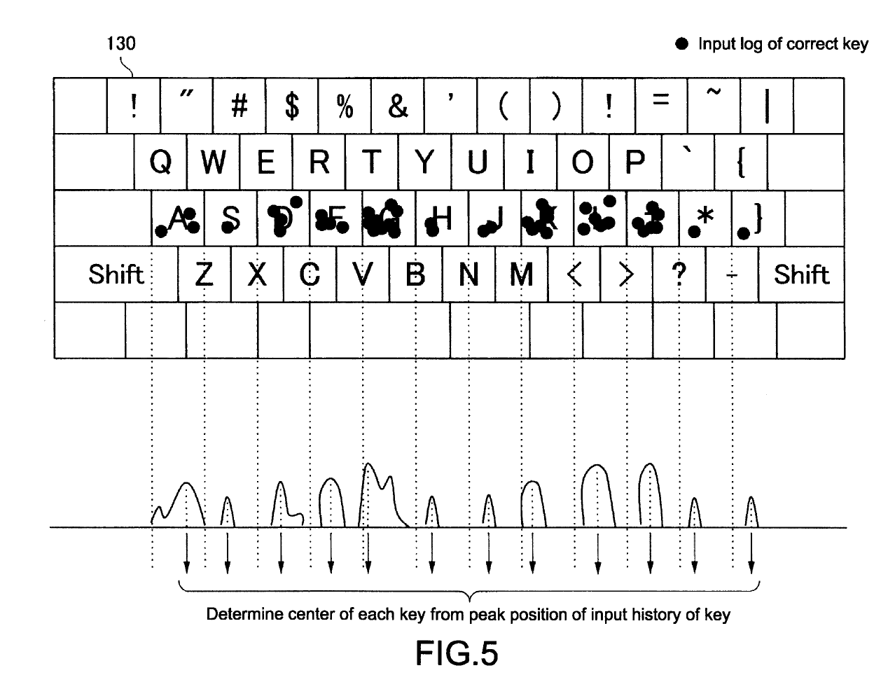

Next, an automatic display change method for a software keyboard according to a second embodiment of the present invention will be described using an example of a display screen operation of a PC 100 shown in FIG. 5. It should be noted that the PC 100 according to this embodiment also includes a housing 140 including a touch panel 110, in which a predetermined software keyboard 130 is displayed on a display screen 120, as shown in FIG. 1.

[Operation Example of Display Screen of PC]

In FIG. 5, a user hits keys on the third row of the software keyboard 130. On the other hand, the key input history storage section 150 stores logs (history information of correct input operation) of user operations made to the software keyboard 130, which are detected using the touch panel 110. In this embodiment, as will be described later, the center of each key is determined from a peak position of the input history of the key.

[Functional Structure of PC]

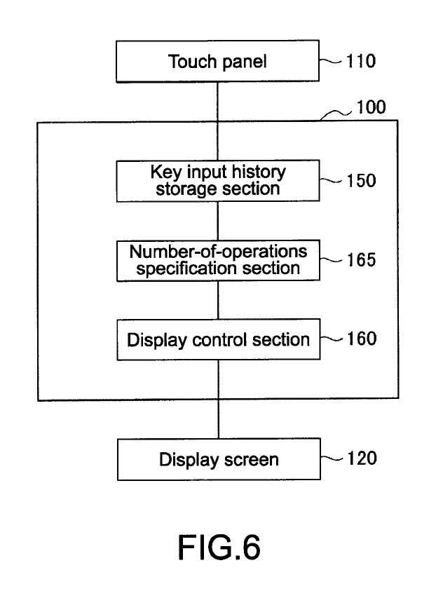

A functional structure of the PC 100 according to this embodiment will be described with reference to FIG. 6. The PC 100 includes a key input history storage section 150, a number-of-operations specification section 165, and a display control section 160.

The number-of-operations specification section 165 specifies the number of operations made to each key of the software keyboard 130, and based on the specified number of operations made to each key, obtains a peak position of the operations made to each key. Thus, a peak position of each key is obtained as shown below the software keyboard 130 in FIG. 5.

The display control section 160 automatically changes a key width based on the number of operations made to each key, which is specified by the number-of-operations specification section 165. On the display screen 120, the software keyboard 130 with the changed keys is displayed.

[Display Change of Software Keyboard]

In this embodiment, based on the number of operations of each key (note that only history information of correct input operations is used), the display of each key is automatically changed. For example, keys used frequently by a user are increased in size, and keys not used frequently are reduced in size.

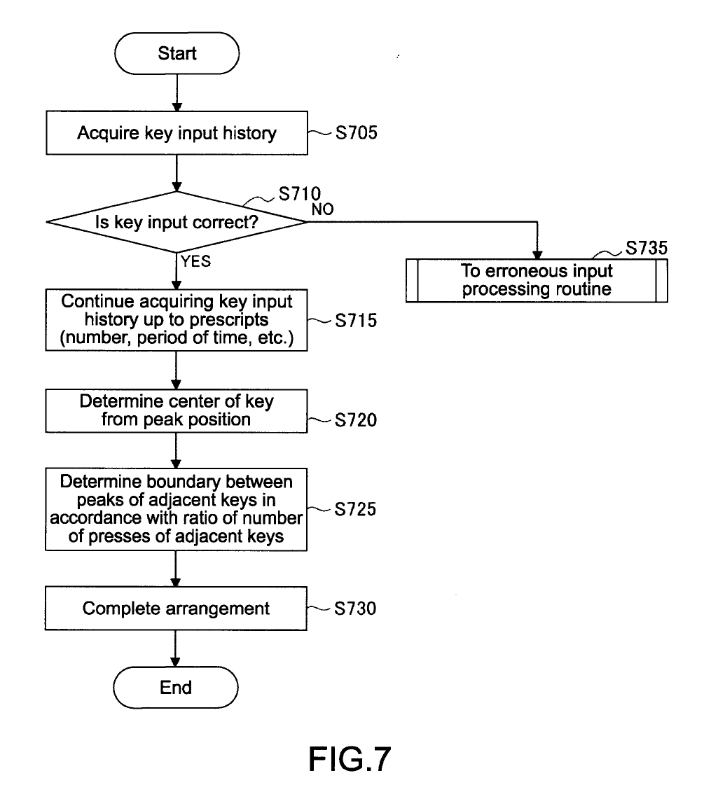

The above operations will be described with reference to a flowchart of the display change processing of the software keyboard 130 shown in FIG. 7. It should be noted that as a premise of starting this processing, it is assumed that the history information (key input history information) of typing positions for each key of the software keyboard 130 is stored in the key input history storage section 150.

First, in S705, the number-of-operations specification section 165 acquires key input history information from the key input history storage section 150. In S710, the number-of-operations specification section 165 judges whether the key input is correct. For example, in a case where an input is made with an A key, when a point within an operation area of the A key is hit, the key input is correct and accordingly the processing proceeds to S715.

In S715, the operations of S705 to S715 are repeated until a predetermined period of time is passed or a predetermined number of pieces of key input history information is obtained, and continues acquiring the key input history information. In S720, the number-of-operations specification section 165 specifies operation positions of each key (coordinate histories) that are included in the key input history information, and obtains a peak position of the operations of each key from the distribution of the operation positions of each key. In S725, the display control section 160 automatically changes the display of each key based on the number of operations made to each key, with the peak position specified by the number-of-operations specification section 165 being set as the center of each key. Specifically, the display control section 160 sets a boundary between the peaks of adjacent keys in accordance with a ratio of the number of operations (number of presses) of the adjacent keys.

Next, in S730, the display control section 160 displays an operation area of the determined key on the display screen 120, and completes the change in arrangement. In addition, in a case where the key input is incorrect in S710, the processing proceeds to S735 and an erroneous input processing routine is executed. The erroneous input processing routine is executed based on the flowchart shown in FIG. 11. The erroneous input processing routine will be described in the third embodiment.

[Results on Display Change of Software Keyboard]

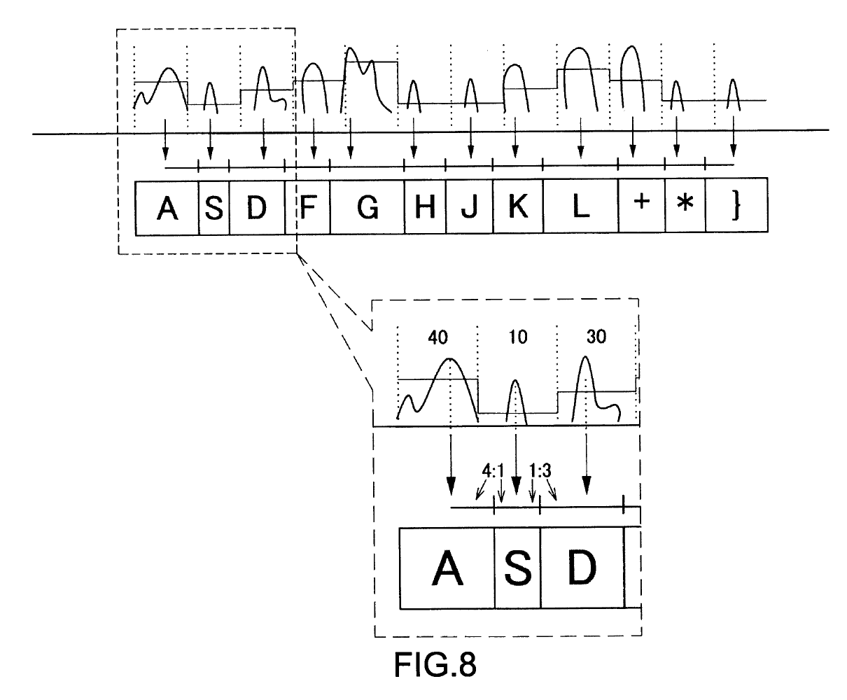

Processing results of this embodiment will be described with reference to FIG. 8. In the upper illustration of FIG. 8, the distribution of the number of operations made to the keys on the third row of the software keyboard 130 is shown and in the lower illustration thereof, an enlarged view of a portion including an A key, an S key, and a D key is shown. In this case, the numbers of operations of the A key, the S key, and the D key are 40, 10, and 30, respectively. In this case, in this embodiment, a peak position of each of the keys becomes the center position of each key. A distance from the center position of a key to a boundary with a key adjacent thereto becomes equal to a ratio of the number of operations. Specifically, in this case, since the numbers of operations of the A key and the S key are 40 and 10, respectively, a ratio of a distance from the center position of the A key to the boundary between the A key and the S key, to a distance from the center position of the S key to the boundary between the A key and the S key becomes 4:1. Similarly, a ratio of a distance from the center position of the S key to a boundary between the S key and the D key, to a distance from the center position of the D key to the boundary between the S key and the D key becomes 1:3.

As described above, in this embodiment, the display control section 160 displays an operation area of a key whose number of operations is large, more largely than that of a key whose number of operations is small, based on the number of operations made to each key. Further, the number-of-operations specification section 165 obtains a peak position of operations made to each key, based on the number of operations made to each key. The display control section 160 changes a display position of each key based on the peak position.

As described above, in this embodiment, the shape of the key is changed in accordance with a correct key input. Further, a key width is determined based on the number of times each key is pressed. Particularly, a boundary between peak positions adjacent to each other is determined in accordance with a ratio of the number of times the adjacent keys are pressed. Accordingly, in this embodiment, an operation area of a key not used frequently is reduced, but an operation area of a key used frequently is increased. Consequently, it is possible to improve the operability of the software keyboard 130, reduce typing errors, raise an input speed, and streamline operations.

It should be noted that when keys are not used by a predetermined number of times or more per unit time, the key operation area can be reduced, or the key operation area can be left as it is without change. Further, in this embodiment, the boundary between the keys adjacent in the lateral direction is changed. However, a boundary between keys adjacent in a vertical direction can be changed or both the boundaries between the keys adjacent in the lateral and vertical directions may be changed.

### Third Embodiment

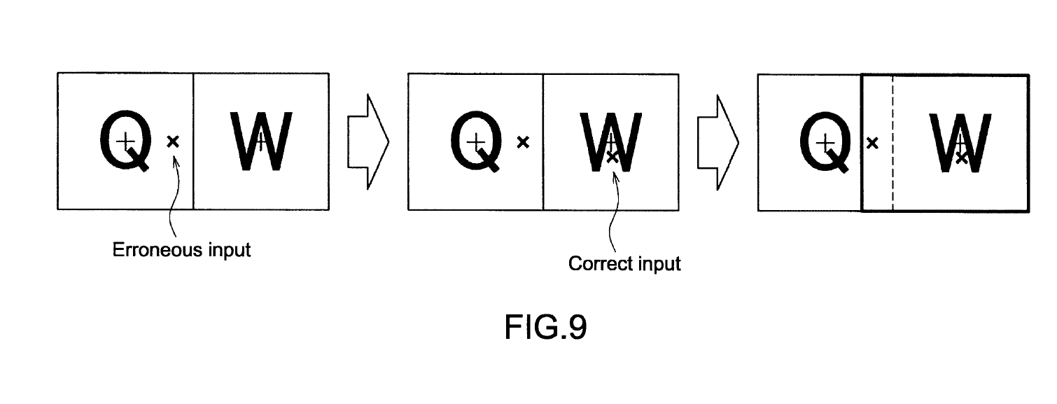

Next, an automatic display change method for a software keyboard according to a third embodiment of the present invention will be described using an example of a display screen operation of a PC 100 shown in FIG. 9. It should be noted that the PC 100 according to this embodiment also includes a housing 140 including a touch panel 110, in which a predetermined software keyboard 130 is displayed on a display screen 120, as shown in FIG. 1.

[Example of Erroneous Input of PC]

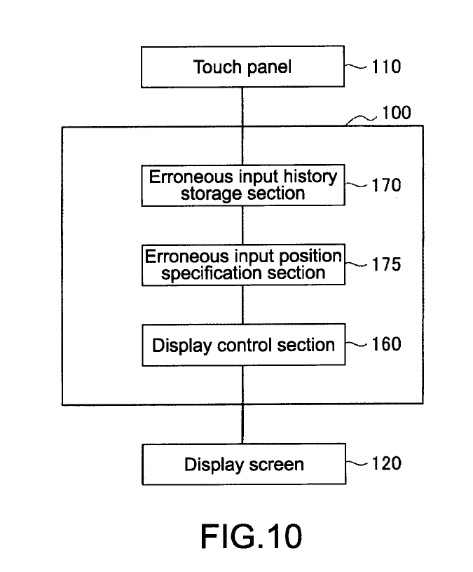

The left-side illustration of FIG. 9 shows a case where a user touches a Q key though intending to hit a W key, and an erroneous input is made. Then, the user deletes the input Q with a BS (DEL) key. At this time, an erroneous input history storage section 170 shown in FIG. 10 stores the erroneous input as erroneous input history information for the W key closest to the operation position. It should be noted that the erroneous input history storage section 170 judges an erroneous input in a case where one letter is deleted with the BS (DEL) key, but the erroneous input history storage section 170 does not store the erroneous input as erroneous input history information, because when two or more letters are deleted, the erroneous input history storage section 170 hardly judges which letter is erroneously input.

In addition, in the middle illustration of FIG. 9, the user touches the W key while intending to touch the W key. This is a correct input operation, and accordingly the user determines the input with the Enter key or the like. At this time, the key input history storage section 150 stores input history information of the W key, but the erroneous input history storage section 170 does not operate in this case.

[Functional Structure of PC]

A functional structure of the PC 100 according to this embodiment will be described with reference to FIG. 10. The PC 100 includes an erroneous input history storage section 170, an erroneous input position specification section 175, and a display control section 160.

The erroneous input history storage section 170 stores the erroneous input history information as described above. The erroneous input position specification section 175 specifies an erroneous input position of each key of the software keyboard 130 based on the erroneous input history information stored in the erroneous input history storage section 170.

The display control section 160 automatically changes the display of each key based on the erroneous input position of each key, which is specified by the erroneous input position specification section 175. On the display screen 120, the software keyboard 130 with the changed keys is displayed.

[Display Change of Software Keyboard]

In this embodiment, based on the number of erroneous operations of each key (that is, only history information of erroneous input operations is used), the display of each key is automatically changed. For example, keys erroneously touched by a user frequently are increased in size, and keys erroneously touched by a user less frequently are reduced in size.

The above operations will be described with reference to a flowchart of the display change processing of the software keyboard 130 shown in FIG. 11. It should be noted that as a premise of starting this processing, it is assumed that the erroneous input history information for each key is stored in the erroneous input history storage section 170.

First, in S1105, the erroneous input position specification section 175 acquires erroneous input history information from the erroneous input history storage section 170. In S1110, the erroneous input position specification section 175 judges whether a deleted key is one (one letter). In a case where a deleted key is one, the processing proceeds to S1115.

In S1115, the operations S1105 to S1115 are repeated until a predetermined period of time is passed or a predetermined number of pieces of erroneous input history information is obtained, and continues acquiring the erroneous input history information. In S1120, the erroneous input position specification section 175 specifies operation positions of each key (coordinate histories) that are included in the erroneous input history information, and increases a key width to a position where an erroneous input is made. In S1125, the display control section 160 widens an operation area of each key to the key width specified by the erroneous input position specification section 175, and displays the operation area on the display screen 120, thus completing the change in arrangement.

On the other hand, in a case where the erroneous input position specification section 175 judges that the deleted key is not one (one letter) in S1110, the processing proceeds to S1130. In S1130, the erroneous input position specification section 175 deletes the deleted acquisition history (erroneous input history information) from the erroneous input history storage section 170.

It should be noted that the above processing in FIG. 11 can be used independently in the third embodiment, or used for the erroneous input processing routine that appears during the processing in the first and second embodiments (FIGS. 4, 7).

[Results on Display Change of Software Keyboard]

As the processing results of this embodiment, as shown in the right-side illustration of FIG. 9, the width of the W key is widened to the position at which an erroneous input is made.

As described above, in this embodiment, the display control section 160 changes a display position of each key based on the erroneous input positions of each key. Specifically, the display control section 160 displays an operation area of a key erroneously input with frequency more largely than that of a key erroneously input with less frequency, based on the erroneous input positions of the keys.

In this manner, the shape of the key is changed in accordance with an erroneous key input. Accordingly, in this embodiment, an operation area of a key erroneously input is increased. Consequently, it is possible to improve the operability of the software keyboard 130, reduce typing errors, raise an input speed, and streamline operations.

It should be noted that the display control section 160 may move a display position of a key adjacent to each key, or change an operation area thereof based on the erroneous input positions of the keys.

Further, the operation area of a key may be widened to a position at which an erroneous input is detected, or may be widened in a stepwise manner by a given width. Further, in this embodiment, the boundary between the keys adjacent in the lateral direction is changed. However, a boundary between keys adjacent in a vertical direction can be changed or both the boundaries between the keys adjacent in the lateral and vertical directions may be changed.

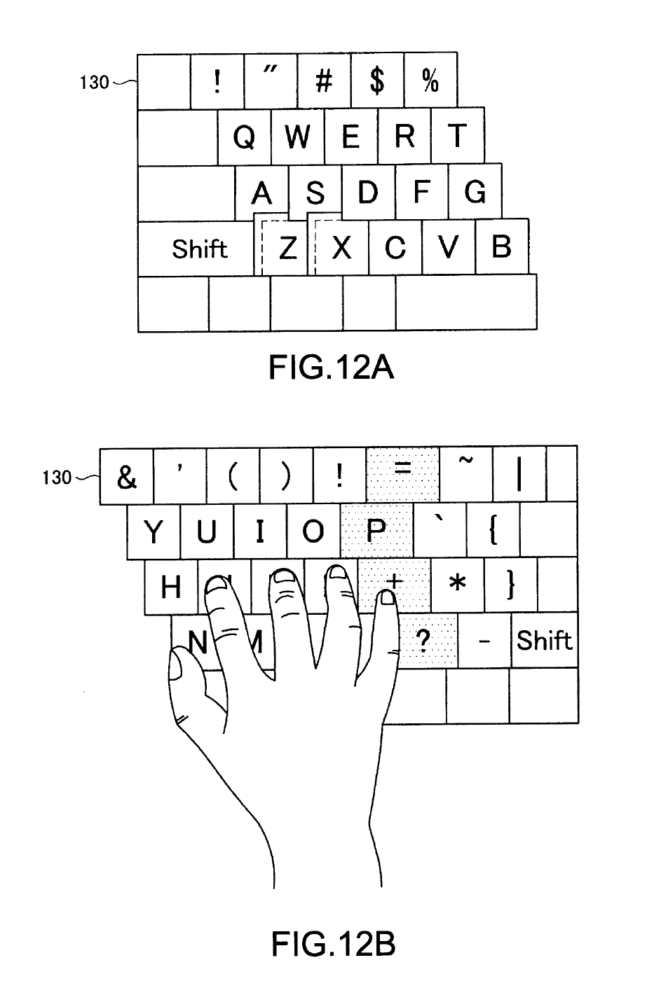

A display change method for a software keyboard will be described in detail with reference to FIGS. 12A and 12B.

FIG. 12A shows a display method in which erroneous input data is reflected for each key. Here, erroneous inputs are caused on a Z key and an X key. In this case, on each of the Z key and the X key, the operation area is widened in the lateral boundary and the vertical boundary. In this manner, the display control section 160 may perform the display change for each key.

FIG. 12B shows a display method in which erroneous input data is reflected for each finger. Here, many erroneous inputs are caused with a little finger. In this case, lateral boundaries are widened by a predetermined width for all keys for which the lithe finger is used at a time of input, i.e., a “=” key, a P key, a “+” key, and a “?” key. In this manner, the display control section 160 may perform the display change for each finger in conjunction with a plurality of keys.

### MODIFIED EXAMPLE

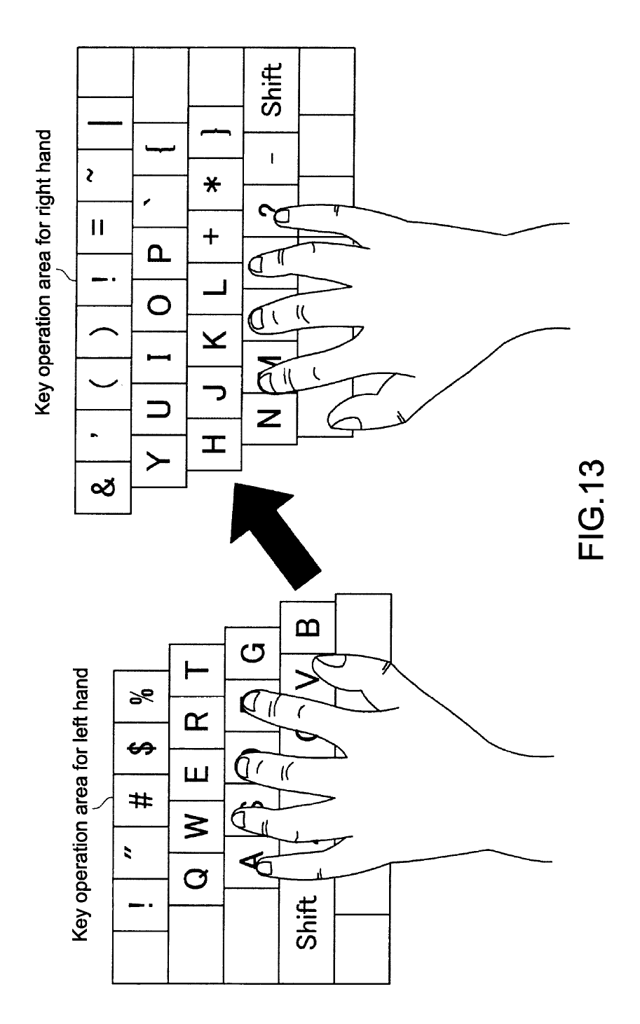

Finally, a display change method for a software keyboard according to a modified example will be described with reference to FIG. 13.

FIG. 13 shows a display method in which erroneous input data is reflected for each hand. For example, an erroneous input may be caused in some cases when one hand is shifted during key inputting. In a case of FIG. 13, the right hand is shifted obliquely rightward as compared to the left hand, and is away from the left hand. Therefore, it is easier to make inputs when input positions are shifted.

In this regard, in the modified example, a key operation area for the right hand is shifted obliquely rightward of a key operation area for the left hand, and the key operation area for the right hand and the key operation area for the left hand are displayed so as to be separated from each other. In this manner, the display control section 160 may judge shifts of a plurality of keys for each hand, and change the display so as to move the entire keyboard, the key operation area for the right hand (keyboard on the right side), and the key operation area for the left hand (keyboard on the left side) in conjunction with one another.

As described above, in the modified example, the display position of the software keyboard 130 or display of the operation areas of the keys can be changed in various units. Accordingly, it is possible to improve the operability of the software keyboard 130, reduce typing errors, raise an input speed, and streamline operations.

According to the embodiments and the modified example described above, the software keyboard automatically adjusts the position of keys, shape of keys, and size of keys to the operations and preference of the user, while a user does not become conscious of the position of keys. Accordingly, it is possible to improve the operability of the software keyboard.

In the first to third embodiments, the operations of the respective sections are associated with one another, and can be replaced by each other as a series of operations and a series of processing while taking the mutual association into consideration. With this structure, the embodiments of the display apparatus can be applied to embodiments of a program for causing a computer to realize a function that the display apparatus has, and a storage medium storing the program.

With this structure, it is possible to provide a program causing a computer to execute: a function of a display apparatus including a housing that includes a touch panel and is configured to display a predetermined software keyboard including keys on a display screen; a function of an operation position specification section configured to specify an operation position of each of the keys of the software keyboard; and a function of a display control section configured to automatically change display of the keys based on variations of the operation positions of the keys, the operation positions being specified by the operation position specification section.

Further, with this structure, it is possible to provide a storage medium storing a program causing a computer to execute: a function of a display apparatus including a housing that includes a touch panel and is configured to display a predetermined software keyboard including keys on a display screen; a function of an operation position specification section configured to specify an operation position of each of the keys of the software keyboard; and a function of a display control section configured to automatically change display of the keys based on variations of the operation positions of the keys, the operation positions being specified by the operation position specification section.

Further, with this structure, it is possible to provide a program causing a computer to execute: a function of a display apparatus including a housing that includes a touch panel and is configured to display a predetermined software keyboard including keys on a display screen; a function of an number-of-operations specification section configured to specify the number of operations made to each of the keys of the software keyboard; and a function of a display control section configured to automatically change display of the keys based on the number of operations made to the keys, the number of operations being specified by the number-of-operations specification section.

Further, with this structure, it is possible to provide a storage medium storing a program causing a computer to execute: a function of a display apparatus including a housing that includes a touch panel and is configured to display a predetermined software keyboard including keys on a display screen; a function of an number-of-operations specification section configured to specify the number of operations made to each of the keys of the software keyboard; and a function of a display control section configured to automatically change display of the keys based on the number of operations made to the keys, the number of operations being specified by the number-of-operations specification section.

Further, with this structure, it is possible to provide a program causing a computer to execute: a function of a display apparatus including a housing that includes a touch panel and is configured to display a predetermined software keyboard including keys on a display screen; a function of an erroneous input position specification section configured to specify an erroneous input position of each of the keys of the software keyboard; and a function of a display control section configured to automatically change display of the keys based on the erroneous input positions of the keys, the erroneous input positions being specified by the erroneous input position specification section.

Further, with this structure, it is possible to provide a storage medium storing a program causing a computer to execute: a function of a display apparatus including a housing that includes a touch panel and is configured to display a predetermined software keyboard including keys on a display screen; a function of an erroneous input position specification section configured to specify an erroneous input position of each of the keys of the software keyboard; and a function of a display control section configured to automatically change display of the keys based on the erroneous input positions of the keys, the erroneous input positions being specified by the erroneous input position specification section.

Hereinabove, the suitable embodiments of the present invention will be described in detail with reference to the attached drawings, but the present invention is not limited thereto. It is apparent that a person having an ordinary skill in the technical field to which the present invention pertains can arrive at various modified examples or corrected examples in the category of the technical idea disclosed in claims, and it is understood that those examples are naturally included in the technical range of the present invention.

For example, in the embodiments described above, the PC is exemplified as a display apparatus, but the display apparatus according to an embodiment of the present invention is not limited thereto. For example, the display apparatus according to an embodiment of the present invention can be used in information processing apparatuses such as a laptop PC and a desktop PC. Further, the display apparatus according to an embodiment of the present invention is not limited to PCs, and can be used in, for example, portable terminals such as a cellular phone, a portable music player, and a PDA (Personal Digital Assistant).

Further, the display control section according to an embodiment of the present invention may change the display of the keys with respect to the operations made to the software keyboard 130 in a predetermined period of time or more, or change the display of the keys with respect to a predetermined number of operations or more made to the software keyboard 130.

Further, the display control section according to an embodiment of the present invention can determine a maximum value and a minimum value of the operation area of a key in advance, and can set the operation area so as not to be too smaller than the minimum value of the operation area of the key, or too larger than the maximum value of the operation area of the key.

It should be noted that a switch to turn on/off the function of the display apparatus according to an embodiment of the present invention can also be provided. For example, it may be possible to update the display of the software keyboard 130 with use of the display change method according to an embodiment of the present invention when a PC serving as the display apparatus according to an embodiment of the present invention is activated, and not to change the display of the software keyboard 130 until the next activation. Accordingly, the processing load on the CPU can be reduced.

The erroneous input processing routine of the first and second embodiments may not be indispensable for the first and second embodiments, and may be present or absent in the first and second embodiments. In a case where the erroneous input processing routine is executed in the first and second embodiments, the erroneous input history storage section 170 and the erroneous input position specification section 175 (see FIG. 10 of third embodiment) are included in the functional structure of the PC 100 shown in FIGS. 2 and 6.

In the present invention, it is possible to identify a user and display a software keyboard applied to the identified user, out of software keyboards stored for each user in advance.

The present application contains subject matter related to that disclosed in Japanese Priority Patent Application JP 2010-010405 filed in the Japan Patent Office on Jan. 20, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus, comprising:
a housing including a touch panel, configured to display a predetermined software keyboard including keys on a display screen;
an operation position specification section configured to specify an operation position of each of the keys of the software keyboard; and
a display control section configured to automatically change display of the keys based on variations of the operation positions of the keys, the operation positions being specified by the operation position specification section.

2. The display apparatus according to claim 1, wherein
the display control section displays an operation area of the key having a large variation more largely than that of the key having a small variation based on the variations of the operation positions of the keys.

3. The display apparatus according to claim 1, wherein
the display control section obtains the center of the operation positions of each of the keys based on the variations of the operation positions, and changes a display position of each of the keys in accordance with the obtained center of the operation positions.

4. The display apparatus according to claim 1, wherein
the display control section obtains a standard deviation of each of the keys based on the variations of the operation positions, and sets a width of each of the keys in accordance with a width of the obtained standard deviation.

5. The display apparatus according to claim 4, wherein
when each of the keys is displayed based on the center of the operation positions and the width of the key, and adjacent keys are displayed in an overlapping manner, the display control section sets a portion displayed in the overlapping manner as a dead zone to which a key input is incapable of being made.

6. A display apparatus, comprising:
a housing including a touch panel, configured to display a predetermined software keyboard including keys on a display screen;
a number-of-operations specification section configured to specify the number of operations made to each of the keys of the software keyboard; and
a display control section configured to automatically change display of the keys based on the number of operations made to the keys, the number of operations being specified by the number-of-operations specification section.

7. The display apparatus according to claim 6, wherein
the display control section displays an operation area of the key having a large number of operations more largely than that of the key having a small number of operations based on the number of operations made to the keys.

8. The display apparatus according to claim 6, wherein
the number-of-operations specification section obtains a peak position of the operations made to each of the keys based on the number of operations made to each of the keys, and
the display control section changes a display position of the key based on the peak position.

9. The display apparatus according to claim 6, wherein
the display control section sets a boundary between the peak positions of adjacent keys in accordance with a ratio of the numbers of operations of the adjacent keys.

10. The display apparatus according to claim 1, further comprising
an erroneous input position specification section configured to specify an erroneous input position of each of the keys of the software keyboard, wherein
the display control section automatically changes display of the keys based on the erroneous input positions of the keys, the erroneous input positions being specified by the erroneous input position specification section.

11. A display apparatus, comprising:
a housing including a touch panel, configured to display a predetermined software keyboard including keys on a display screen;
an erroneous input position specification section configured to specify an erroneous input position of each of the keys of the software keyboard; and
a display control section configured to automatically change display of the keys based on the erroneous input positions of the keys, the erroneous input positions being specified by the erroneous input position specification section.

12. The display apparatus according to claim 11, wherein
the display control section displays an operation area of the key having a large number of erroneous inputs more largely than that of the key having a small number of erroneous inputs based on the erroneous input positions of the keys.

13. The display apparatus according to claim 11, wherein
the display control section changes a display position of each of the keys based on the erroneous input positions of the keys.

14. The display apparatus according to claim 11, wherein
the display control section changes at least one of a display position and an operation area of a key adjacent to each of the keys based on the erroneous input positions of the keys.

15. The display apparatus according to claim 11, wherein
the display control section changes display of at least one of a key operation area for a right hand and a key operation area for a left hand, based on the erroneous input positions of the keys.

16. The display apparatus according to claim 1, wherein
the display control section changes display of the keys by varying a boundary position of each key one of per given period of time during which the software keyboard is operated and per given number of times typing is made on the software keyboard.

17. A program causing a computer to execute:
a function of a display apparatus including a housing that includes a touch panel and is configured to display a predetermined software keyboard including keys on a display screen;
a function of an operation position specification section configured to specify an operation position of each of the keys of the software keyboard; and
a function of a display control section configured to automatically change display of the keys based on variations of the operation positions of the keys, the operation positions being specified by the operation position specification section.

18. A program causing a computer to execute:
a function of a display apparatus including a housing that includes a touch panel and is configured to display a predetermined software keyboard including keys on a display screen;
a function of a number-of-operations specification section configured to specify the number of operations made to each of the keys of the software keyboard; and
a function of a display control section configured to automatically change display of the keys based on the number of operations made to the keys, the number of operations being specified by the number-of-operations specification section.

19. A program causing a computer to execute:
a function of a display apparatus including a housing that includes a touch panel and is configured to display a predetermined software keyboard including keys on a display screen;
a function of an erroneous input position specification section configured to specify an erroneous input position of each of the keys of the software keyboard; and
a function of a display control section configured to automatically change display of the keys based on the erroneous input positions of the keys, the erroneous input positions being specified by the erroneous input position specification section.
